(19) United States
(12) Patent Application Publication
(10) Pub. No.: US 2011/0127744 A1
(43) Pub. Date: Jun. 2, 2011

(54) DAMPING BUSHING FOR TORSION-BEAM REAR AXLE OF A MOTOR VEHICLE

(75) Inventors: Juergen SIEBENEICK, Oberwesel (DE); Michael HARDER, Bodenheim (DE); Gerd BITZ, Mainz (DE); Oleg MAZUR, Nauheim (DE); Dirk EHRLICH, Bodenheim (DE)

(73) Assignee: GM GLOBAL TECHNOLOGY OPERATIONS, INC., Detroit, MI (US)

(21) Appl. No.: 12/889,348

(22) Filed: Sep. 23, 2010

(30) Foreign Application Priority Data
Sep. 30, 2009 (DE) 102009043552.2

(51) Int. Cl. F16F 1/38; F16F 7/00; F16F 1/393; B60G 21/05; B60G 3/12

(52) U.S. Cl. 280/124.128; 267/141.7; 280/124.106

(57) ABSTRACT

A damping bushing is provided for an axle bearing of a trailing arm of a torsion-beam rear axle for a motor vehicle, in particular for an automobile, which includes, but is not limited to a bushing outer sleeve, a bushing inner sleeve, and a damping body. The interposed damping body is disposed coaxially to the bushing outer sleeve and to the bushing inner sleeve between these two elements. The bushing inner sleeve forms a radially outwardly extending spherical surface and the damping bushing has at least one further element that abuts extensively against the spherical surface formed by the bushing inner sleeve. Furthermore, a torsion-beam axle is provided that is fitted with these bushings.

### CROSS-REFERENCE TO RELATED APPLICATION

This application claims priority to German Patent Application No. 102009043552.2, filed Sep. 30, 2009, which is incorporated herein by reference in its entirety.

### TECHNICAL FIELD

The present invention relates to a damping bushing for a trailing arm axle bearing of a torsion-beam (rear) axles for a motor vehicle, in particular an automobile. The invention further relates to a torsion-beam rear axle fitted with such a damping bushing for a motor vehicle.

### BACKGROUND

Torsion-beam rear axles usually have two wheel-carrying trailing arms, which are connected by means of a cross-tie. In this context, the connection between trailing arm and cross-tie can be configured, for example, to be screwed, welded, or glued. The trailing arms are possibly fastened on the vehicle body by means of guide bearings. The cross-tie usually sits ahead of the wheel center and absorbs all vertical and lateral moments of force. On account of the swiveling of the arms with respect to one another, the cross-tie is configured to be torsionally soft and in addition, frequently flexurally stiff. It usually acts simultaneously as a stabilizer. Various embodiments of torsion-beam rear axles designed for different cases of application are known from the Unexamined Laid-Open Patent Application DE 10 2007 043 121 A1 of the applicant.

Damping bushings for trailing arm axle bearings of torsion-beam rear axles are furthermore known from DE 10 2007 043 121 A1. Described here, for example, are damping bushings having a thrust body having a thrust segment and a thrust sleeve extending in the damping bushing axial direction, a substantially cylindrical damping body, and a substantially cylindrical bushing jacket. The damping body is disposed coaxially to the bushing jacket and to the thrust sleeve between these two elements. The damping body has a damping effect at least in its direction of extension aligned coaxially to the damping bushing axial direction. Further known from DE 4447971 B4 is a torsion-beam axle (hereinafter designated as CC) and from DE 102006033755, another torsion-beam axle with a so-called Watt linkage (hereinafter designated as CCWL), which can also have A-damping bushings.

In practice, it has been found with the damping bushings which have proved extremely successful that the attainable acoustic and mechanical driving comfort can be optimized still further. In addition, the attainable driving comfort is also capable of improvement with a view to the increased demands of the customers. However, it is known that in torsion-beam axles without a Watt linkage that there is a conflict of aims when optimizing driving stability and acoustic as well as mechanical driving comfort. In order to improve the driving stability, the damping bushing must be configured to be as stiff as possible. In order to optimize the acoustic and mechanical driving comfort, on the other hand, the damping bushing must be configured to be particularly soft.

It is further known that when the known damping bushings are used in torsion-beam axles with a Watt linkage, their lifetime is reduced if the bushings have particularly high elasticity or resilience, which is desired per se on account of improved acoustic and mechanical comfort properties. A second conflict of aims is therefore present here. Accordingly, in the damping bushings known from practice, compromises must furthermore be made depending on the system when optimizing the driving stability while at the same time optimizing the driving comfort.

In addition, it has been found in practice that the deformation behavior of a torsion-beam rear axle, such as is described in DE 4447971 B4 (CC design), depends on the configuration of the damping bushing under lateral force which driving through curves. A spring wind-up is usually formed in the transverse profile with bilateral spherical mounting of the trailing arms. On the axle side loaded under lateral force when driving through curves, this leads to the over steer behavior typical of torsion-beam rear axles, which has a negative effect on the driving stability.

Accordingly, it is at least one object of one embodiment of the present invention, while avoiding the disadvantages discussed hereinbefore and at least partially resolving the conflicts of aims which have been described, to provide a damping bushing for a trailing arm axle bearing of a torsion-beam rear axle, by which means it is possible to improve the acoustic and mechanical driving comfort while simultaneously taking into account the highest possible driving stability and improved lifetime by optimizing the damping bushing. Another object is to provide an improved torsion-beam rear axle equipped therewith. In addition, other objects, desirable features, and characteristics will become apparent from the subsequent summary and detailed description, and the appended claims, taken in conjunction with the accompanying drawings and this background.

### SUMMARY

A damping bushing is provided for an axle bearing of a trailing arm of a torsion-beam rear axle for a motor vehicle, in particular for an automobile, comprising a bushing outer sleeve, a bushing inner sleeve, and a damping body, wherein the damping body is disposed coaxially to the bushing outer sleeve and to the bushing inner sleeve between these two elements, wherein the bushing inner sleeve forms a radially outwardly extending spherical surface and the damping bushing has at least one further element which abuts extensively against the spherical surface formed by the bushing inner sleeve or abuts flush there.

The proposed damping bushing can be firmly connected to the torsion-beam rear axle in a manner fixed to the axle and to the vehicle body in a manner fixed to the body. The orientation of the damping bushing can either be vertical, wherein the bushing central axis is aligned approximately vertically or at a small angle to the vertical or horizontally, wherein the bushing central axis is aligned approximately vertically or slightly at an inclination to the direction of travel.

The damping effect of the damping bushing is appreciably improved by the ball-joint-like configuration and is preferably selected in such a manner that a torsion rate oriented in the axial direction of the damping bushing or rotational stiffness C1 and a torsion rate likewise oriented in the axial direction of the damping bushing or rotational stiffness C2 are better decoupled from movements of the vehicle body or from movements of the axle in the X, Y, and Z direction. The partially ball-like configuration of the damping bushing further improves the cardanic properties, which is in particular the twistability of the damping bushing during compression and extension. The proposed damping bushing therefore has a high resilience and good cardanic properties while simultaneously maintaining or increasing the lifetime.

In one exemplary embodiment, the element which abuts extensively on the bushing inner sleeve can be formed on the damping body itself, for example, as a vulcanization layer. The vulcanization layer of the damping body then forms the contact surface for the said spherical surface of the bushing inner sleeve. As a result of the small number of components, this embodiment is particularly easy to manufacture and a certain, albeit small, ball joint function can already be achieved in this embodiment. In particular, the torsional forces acting on the damping bushing can be better absorbed by the partial spherical shape of the bushing inner sleeve and the damping body, i.e., shear forces are distributed more uniformly and more extensively, which can lead to a longer usage duration of the damping bushing.

In a further exemplary embodiment, the element is an additional damping element that is disposed coaxially to the damping body and to the bushing inner sleeve between these two elements. Here, the damping of the body movement in the X, Y, and Z direction and the damping of the movement of the rear axle can be efficiently decoupled, in particular since the two damping bodies can have a different damping effect due to their material property and shape.

It is further proposed in another exemplary embodiment that the element is a ball cup element, which is largely disposed coaxially to the damping body and to the bushing inner sleeve between these two elements and forms a ball joint with the bushing inner sleeve. The ball-joint-like configuration of the damping bushing has the result that few or even no torsional forces can act on the damping body since the damping body is simply twisted by the acting forces. Due to particular materials possibly plastics such as polytetrafluoroethylene (PTFE), the ball cup element can slide easily and without any creaking noise on the bushing inner sleeve about a point lying at the center of the damping bushing on the longitudinal axis thereof.

In another embodiment, an intermediate sleeve can be disposed coaxially to the damping body and to the damping element between these two elements, which sleeve imparts more stability to the damping bushing. This intermediate sleeve can also be configured to be spherical, at least in a partial area, in order to improve the already existing advantageous properties of a ball joint.

In a further exemplary embodiment, an outer shell is additionally provided for the ball joint, said outer shell being disposed coaxially to the ball cup element and to the damping body between these two elements.

In a further exemplary embodiment it is provided that the damping bushing has a sealing element, which seals toward the outside at least the spherical surface of the bushing inner sleeve and the element adjoining said sleeve, wherein the sealing element can be configured in particular as sealing bellows in order to protect the damping bushing from contamination and thereby increase its lifetime.

As has already been stated hereinbefore, a torsion-beam rear axle for a motor vehicle is provided, in particular for an automobile, comprising two wheel-carrying trailing arms, which are connected to a torsionally soft cross-tie disposed ahead of the wheel center in the direction of travel and fastened to the vehicle body by means of axle bearings, wherein the respective axle bearings of the two trailing arms are each fitted with a damping bushing as described above according to the invention. The advantages already discussed in detail hereinbefore are therefore achieved undiminished in a synergetic manner.

In one exemplary embodiment, the torsion-beam rear axle can be configured whereby in an operatively installed state of the respective damping bushings, these are firmly connected to an in particular cylindrical bushing retaining element in particular by means of vulcanizing-in or by means of pressing-in.

In one exemplary embodiment, the torsion-beam rear axle can be configured whereby in an operatively installed state of the respective damping bushings, the bushing outer sleeve is at the same time configured as a bushing carrier element for connection to the vehicle body and is fastened thereto.

In one exemplary embodiment, the torsion-beam rear axle can be further developed whereby the front-side ends of the trailing arms each form bearing forks, in which respectively one damping bushing is inserted, wherein the bearing fork is formed in one piece or in multiple pieces.

A further embodiment provides that the bushing outer sleeve of the damping bushing is connected to the vehicle body in a manner fixed to the body. By this means the exterior region with the damping element primarily determines the properties in regard to resilience or stiffness in the X, Y, and Z direction. The interior region with its spherical elements primarily determines the twisting properties or required twisting forces. It is particularly important that the stiffnesses depend less on the instantaneous position of the trailing arm. In a particular embodiment, complete independence can also be achieved between the stiffness of the damping bushing and the position of the trailing arm.

In a preferred embodiment, the respective damping bushing is aligned substantially transversely to the vehicle longitudinal direction with a deviation in a range of up to +/−25o to the vehicle direction.

In a preferred embodiment, the damping body of the damping bushing can be designed to be solid, made of solid rubber. In a further preferred embodiment, this can have one or more free spaces, which are disposed on a circular ring in the damping body arranged coaxially to the bushing longitudinal axis and which extend at least over a part of its longitudinal extension.

The installation space required for fixing the ball cup shell inside the damping bushing can, for example, be provided by forming a recess on the outer shell without the entire dimensions or external dimensions of the damping bushing in any form needing to be enlarged. In this embodiment, the damping bushing can thus be formed in a particularly compact and space-saving manner. In this embodiment, the damping bushing according to the invention still makes do with the tight installation space available in known torsion-beam rear axles.

The torsion rates C1 and C2 of the bushing can be determined by the rubber mixture, the design, and the size of the bushing filling or the damping body.

The bushing outer sleeve and the bushing inner sleeve are made, for example, of metal, preferably of aluminum. These parts can be manufactured as sheet-metal stampings. The damping body and the damping element are made of an elastomer, unvulcanized rubber, or damping materials of this type, preferably of vulcanized rubber. The damping body, for example, has a hardness of approximately 50 Shore.

It is understood that the embodiments described merely relate to preferred embodiments and therefore do not limit the scope of protection. Combinations of the invention which are not explicitly specified should naturally be combined with one another on the basis of this application for the person skilled in the art. The terms “a” or “the”, “this” etc. should not be interpreted to mean that a limitation of the range of protection has been made hereby.

### BRIEF DESCRIPTION OF THE DRAWINGS

The present invention will hereinafter be described in conjunction with the following drawing figures, wherein like numerals denote like elements, and:

FIG. 1 shows an exemplary embodiment of a damping bushing of the invention in full section along its longitudinal axis when installed in a trailing arm;

FIG. 2 shows another exemplary embodiment of a damping bushing of the invention in full section along its longitudinal axis when installed in a trailing arm;

FIG. 3 shows another exemplary embodiment of a damping bushing of the invention in full section along its longitudinal axis when installed in a trailing arm;

FIG. 4 shows another exemplary embodiment of a damping bushing of the invention in full section along its longitudinal axis when installed in a trailing arm;

FIG. 5 shows a schematic diagram of another exemplary embodiment of a damping bushing of the invention in full section along the line of intersection shown in FIG. 6;

FIG. 6 shows a schematic diagram of another exemplary embodiment of a damping bushing according to the invention in full section perpendicular to its longitudinal axis;

FIG. 7 to FIG. 12 each show a principle for the spring properties of a damping bushing in various embodiments;

FIG. 13 shows three different embodiments of torsion-beam rear axles with and without a Watt linkage;

FIG. 14 shows a three-dimensional view of one embodiment of a torsion-beam rear axle with vertical damping bushings with outer sleeves fixed to the body.

FIG. 15 shows a three-dimensional view of a known torsion-beam rear axle with horizontal damping bushings according to an embodiment of the invention.

FIG. 16 shows a three-dimensional view of another embodiment of a known torsion-beam rear axle with horizontal damping bushings according to the invention.

### DETAILED DESCRIPTION

The following detailed description is merely exemplary in nature and is not intended to limit application and uses. Furthermore, there is no intention to be bound by any theory presented in the preceding background or summary the following detailed description.

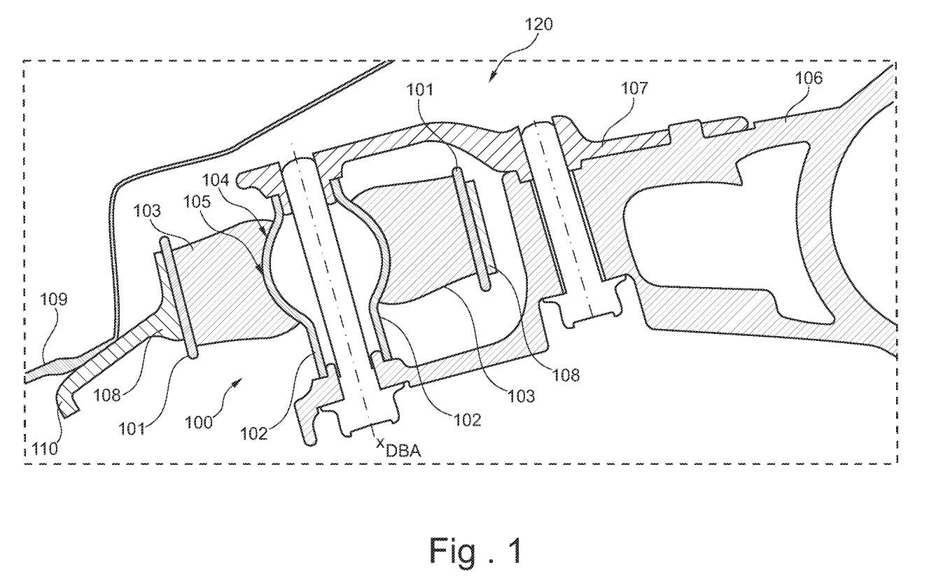

FIG. 1 shows an exemplary embodiment of a damping bushing 100 according to an embodiment of the invention for a torsion-beam rear axle 120 in a section through the damping bushing axial direction XDBA. Assuming that in the real installation case, the front section of the trailing arm shown, which contains the axle bearing and is located ahead of the cross-tie, is not slightly bent from the cross-tie but runs approximately perpendicular to this, the damping bushing axial direction XDBA runs substantially perpendicularly to the roadway or in the Z direction.

The damping bushing 100 for the axle body 120 has a cylindrical bushing outer sleeve 101, a bushing inner sleeve 102, and a damping body 103, wherein the damping body 103 is disposed coaxially to the bushing outer sleeve 101 and to the bushing inner sleeve 102 between these two elements, and wherein the bushing inner sleeve 102 has a radially outwardly extending spherical surface 105. The damping body 103 can be formed from an elastomer, rubber, or similar damping materials. The damping body 103 nestles against the bushing inner sleeve 102 above the spherical surface 104, for example, in the form of a vulcanization layer and is thereby configured to be substantially rotationally symmetric. In the embodiment shown this damping body has in its interior two arcuate or kidney-shaped free volumes, not shown here, distributed uniformly over the circumference, by which means inter alia the damping properties of the damping body 103 can be influenced. The bushing outer sleeve 101 is also configured to be rotationally symmetric. The damping body 103 further has the necessary stiffness for damping the forces acting via the vehicle body. A certain cardanic effect is merely achieved as a result of the spherical surfaces 104, 105 of the bushing inner sleeve and the damping body. The bushing inner sleeve 102 forms a radially outwardly extending spherical surface 104. The damping bushing 100 has, on its damping body 103, another spherical surface 105 nestling extensively against the spherical surface 105 formed by the bushing inner sleeve. In this embodiment, this spherical surface 105 is an element of the damping body 103. FIG. 1 further shows the two-part form of the axle bearing, i.e., a lower axle yoke 106 and an upper closure yoke 107. The two-part form of the axle yoke has the advantage of a smaller installation space compared with a one-part form. The bushing outer sleeve 101 is embraced by a likewise cylindrical bushing retaining element 108, wherein the bushing outer sleeve 101 and the bushing retaining element 108 can be firmly connected to one another by pressing-in. The bushing retaining element 108 further has a carrier 110 which is connected to the body 109 of the vehicle by screwing or welding. In another exemplary embodiment not shown here, the bushing outer sleeve 101 and the bushing retaining element 108 can be formed in one piece.

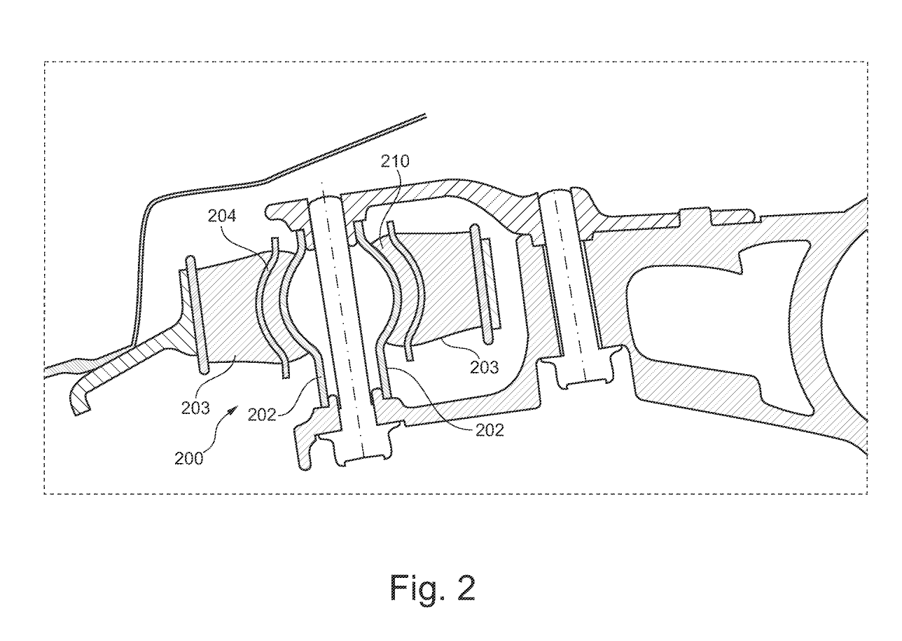

In FIG. 2 the damping bushing 200 has an additional damping element 210 in the form of a layer of rubber, elastomer, or a material having comparable damping properties. The material is preferably selected in such a manner that a sufficient cardanic property, i.e., a sliding capability in relation to the bushing inner sleeve 202 is achieved. On the other hand, the sliding capability can possibly be dispensed with if the material of the damping element 210 allows a twisting under the action of shear or torsional forces as a result of its shape and its material properties. The damping element 210 is disposed coaxially to the damping body 203 and to the bushing inner sleeve 202 between these two elements. More precisely, the damping element 210 is disposed directly between an intermediate sleeve 204, this consisting of metal or of a plastic. In addition to the damping body 203 and the bushing inner sleeve, the intermediate sleeve and the damping element form spherical surfaces which each nestle against the directly adjacent surface.

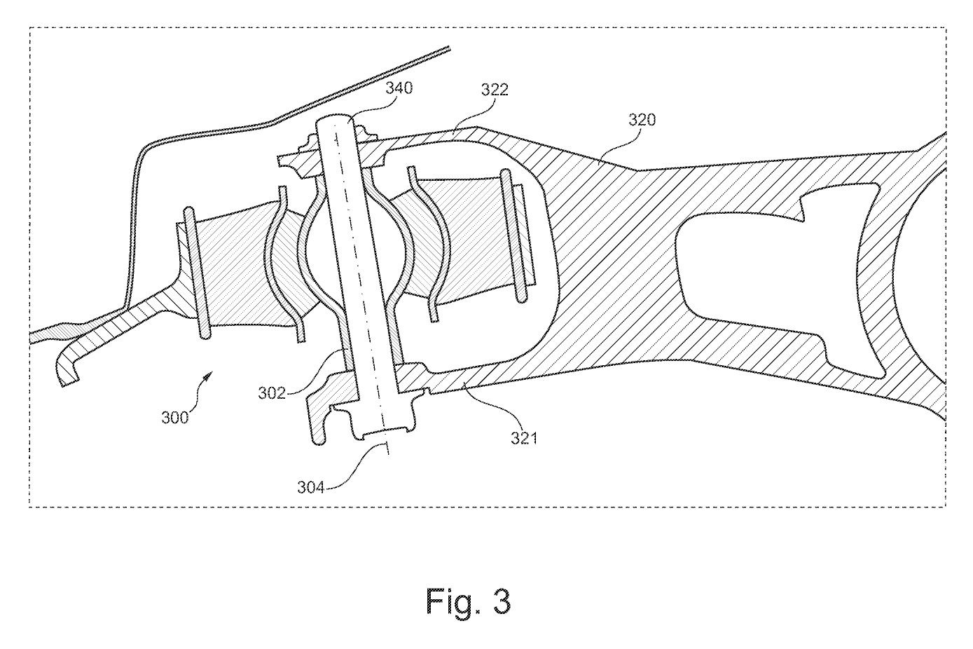

FIG. 3 shows a damping bushing 300 similar to that shown in FIG. 2. In this case, however, the axle body 320 and therefore the axle forks 321, 322 are formed in one piece. The higher installation height is clearly seen. A greater stiffness can be achieved due to the one-part nature of the axle body. It is further shown that unlike the embodiments in FIG. 1 and FIG. 2, the bushing inner sleeve 302 is no longer fastened to inner sleeves of the axle fork but directly on a fixing screw 340 in the axle centre 304 of the damping bushing 300.

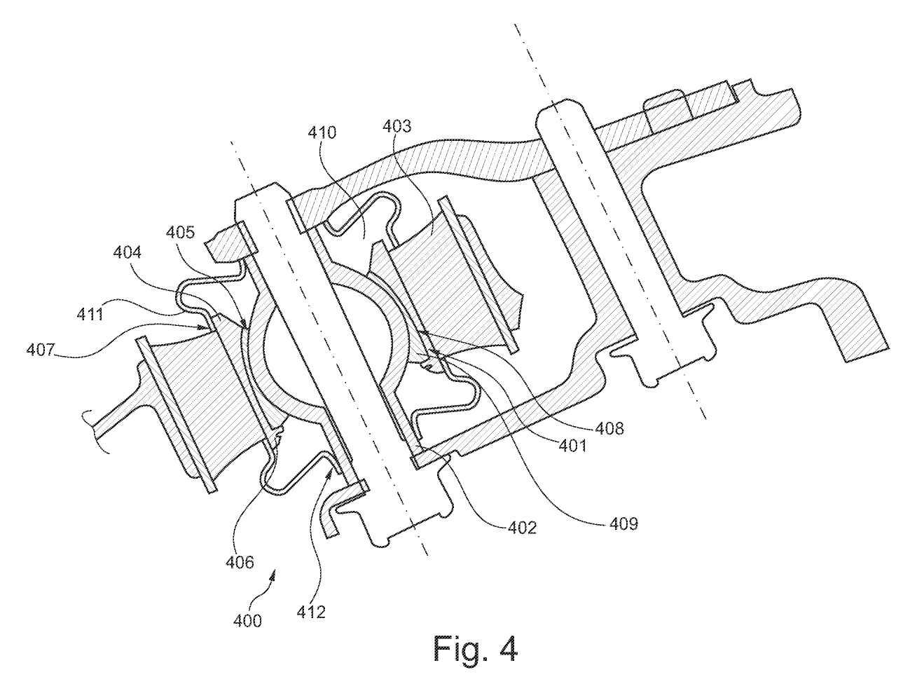

FIG. 4 shows a damping bushing 400 in which the damping and cardanic properties are achieved completely separately. The damping is achieved merely by the damping properties of the damping body 403. The cardanic properties are achieved by the interplay of a bushing inner sleeve 402 and a ball cup element 409, here in the form of a sliding shell of plastic such as polytetrafluoroethylene (PTFE) which together form a ball joint. The ball cup element 409 is displaceable from its central position shown in the direction of the arrow 410 on the larger spherical surface of the bushing inner sleeve 402 in all directions. The contour of the upper side 408 of the ball cup element 409 directly follows the underside 401 of an outer shell 404 for the ball cup element 409 or the ball joint, the outer shell 404 being disposed coaxially to the ball cup element 409 and to the damping body 403 between these two elements. The outer shell 404 consists of a metal, possibly of a steel or an aluminum alloy or of plastic.

For fixing the ball cup element 409 on the bushing inner sleeve 402, the ball cup element 409 which tapers toward its one end 405 is inserted between the bushing inner sleeve 402 and the outer shell 404 and fixed with a fixing ring 406. It is further shown that the upper side of the outer shell adjoins flat against the underside of the damping body and projects with one edge 407. This edge 407 is used for fastening one edge of a sealing element 411 which seals the ball joint toward the outside, the sealing element 411 being configured here as a sealing bellows. At its other edge, the sealing element 411 is connected to one edge 412 of the upper side of the bushing inner sleeve 402. The connection of the sealing element is achieved by means of two clamping rings, not shown here, which fix the sealing element 411 in a groove on the inner sleeve 402 and a groove on the housing 404.

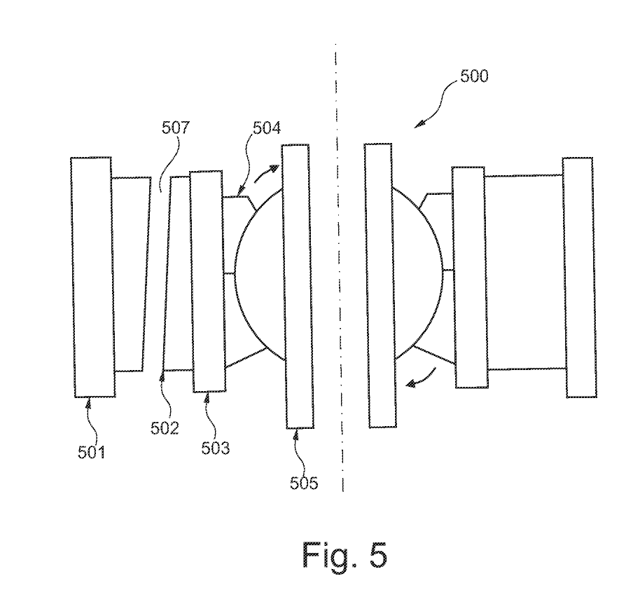

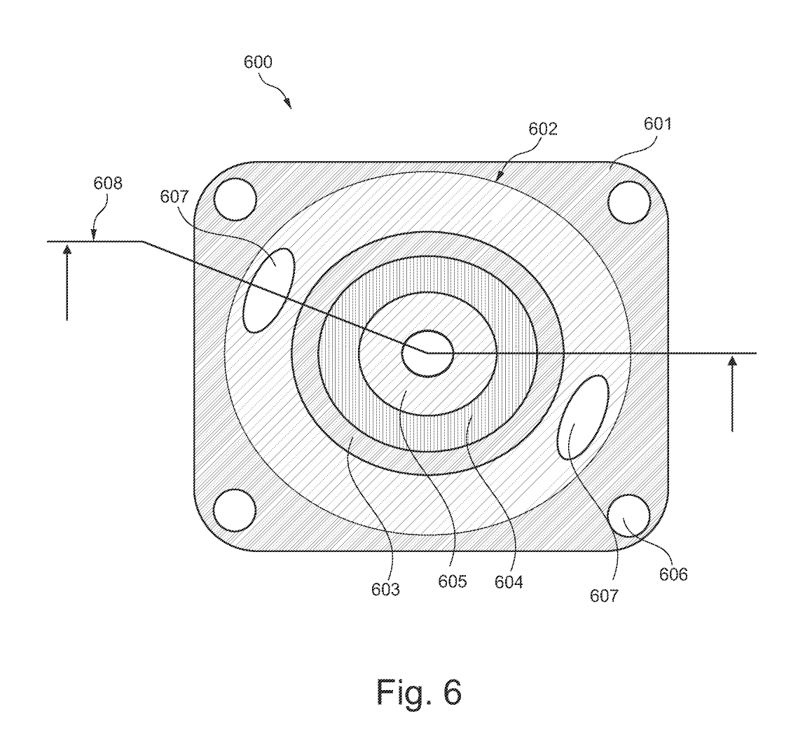

FIG. 5 shows a schematic diagram of a longitudinal section parallel to the central axis of a rotationally symmetrical damping bushing 500 along the line of intersection 608 shown in FIG. 6. The damping bushing 500 is fitted with a cylindrical bushing outer sleeve 501, a cylindrical damping body 502 with free volume 507, a cylindrical intermediate sleeve 503 and fixing ring 504 laser-welded thereto, and with a bushing inner sleeve 505. In this embodiment the intermediate sleeve forms a spherical surface facing the spherical surface of the bushing inner sleeve and adapted to this. The fixing is achieved by means of a fixing ring which also forms a spherical surface. The fixing ring is connected to the intermediate sleeve preferably by laser welding.

FIG. 6 shows another schematic diagram of a cross-section transverse to the central axis of the rotationally symmetric damping bushing 600 shown in FIG. 5 having a cylindrical bushing outer sleeve 601, a cylindrical damping body 602, a cylindrical intermediate sleeve 603 and fixing ring 604 laser-welded thereto, as well as a bushing inner sleeve 605. The through openings 606 provided for the fastening and two free volumes 607 inside the damping body 602 which serve to determine the damping characteristics can be clearly identified.

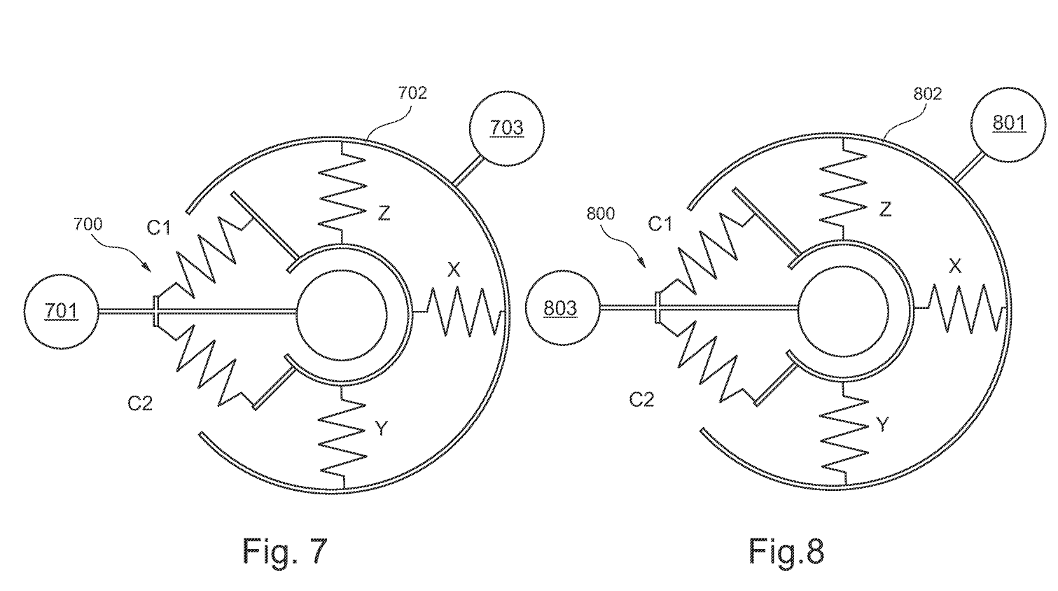

FIG. 7 to FIG. 12 each show a principle for the spring properties of a damping bushing in various embodiments.

In FIG. 7 the bushing inner sleeve 700 is connected to one end of the axle arm 701, the bushing outer sleeve 702 is connected to the body 703. C1 and C2 are the torsion rates for the spherical elements of the damping and X, Y, Z are the damping of the damping element, here in relation to the body.

In FIG. 8 the bushing inner sleeve 800 is connected to the body 803, the bushing outer sleeve 802 is connected to one end of the axle arm 801. C1 and C2 are the torsion rates for the spherical elements of the damping bushing and X, Y, Z are the damping of the damping element, here in relation to the axle arm which can be pivoted with respect to the body.

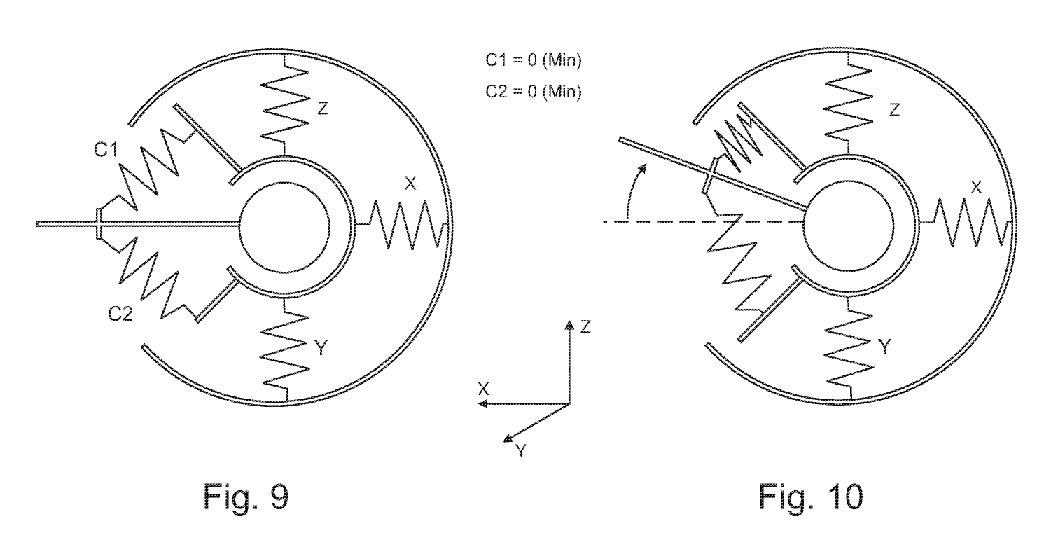

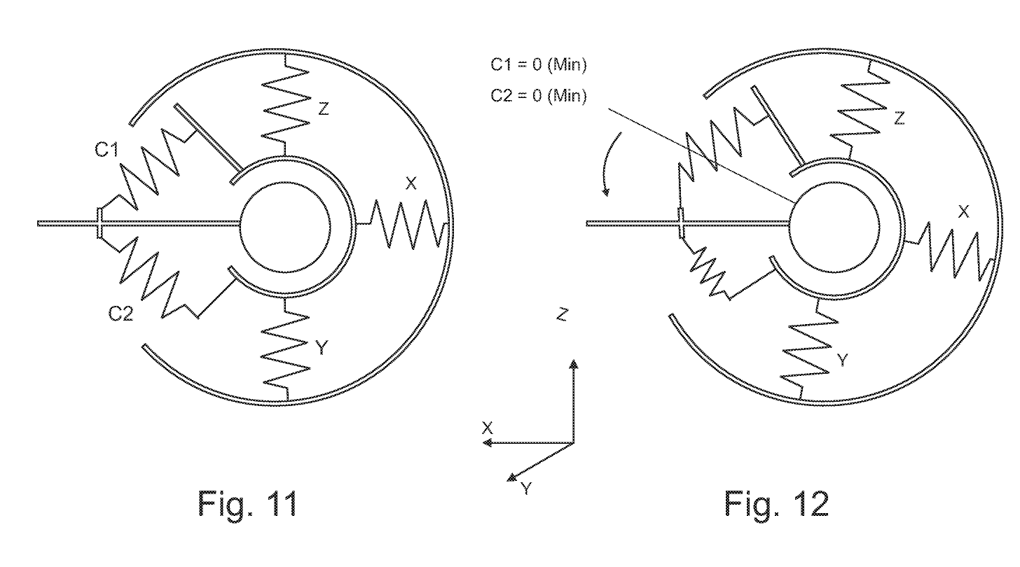

FIG. 9 and FIG. 10 show the deflection and damping effect of the damping bushing for the embodiment shown in FIG. 7. FIG. 11 and FIG. 12 show the deflection for the embodiment shown in FIG. 8.

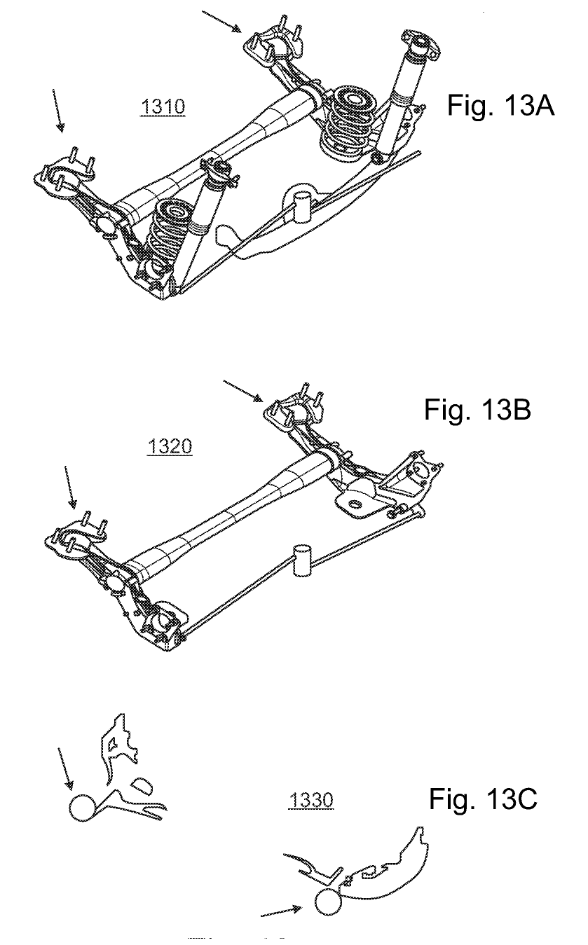

FIG. 13A and FIG. 13B show embodiments of torsion-beam rear axles 1310, 1320 with horizontal damping bushing and Watt linkage characterized here by an arrow in each case. The bushing outer sleeve of the damping bushing is connected to the axle here. FIG. 13C shows a torsion-beam rear axle 1330 with two vertical damping bushings characterized by arrows in accordance with one embodiment of the invention, which are each fixed to the axle with their bushing outer sleeves in a manner fixed to the axle.

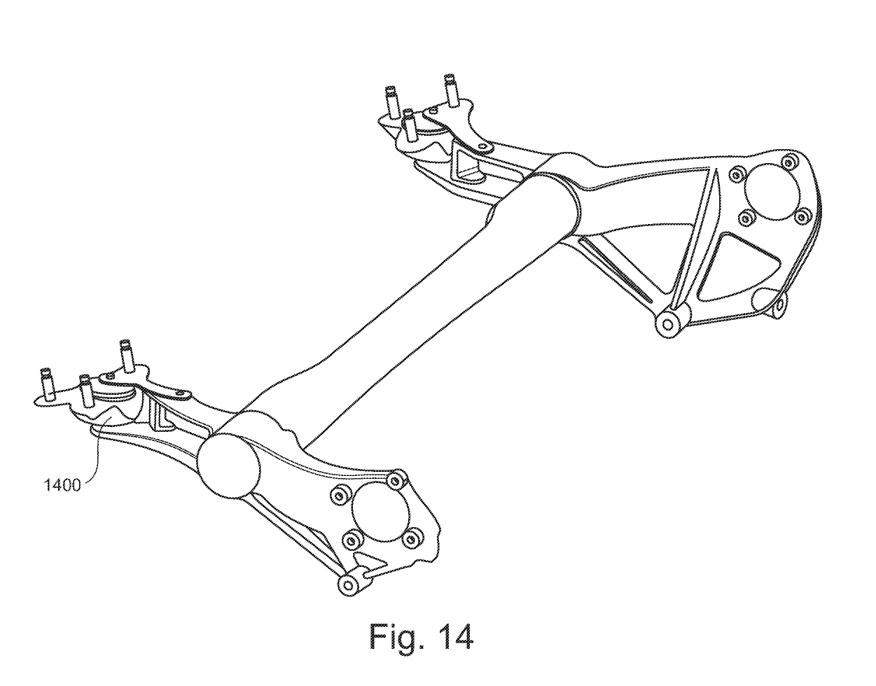

FIG. 14 shows an embodiment of a torsion-beam rear axle 1401 with a vertical damping bushing according to the invention. The bushing outer sleeve 1400 of the damping bushing is here connected to the body.

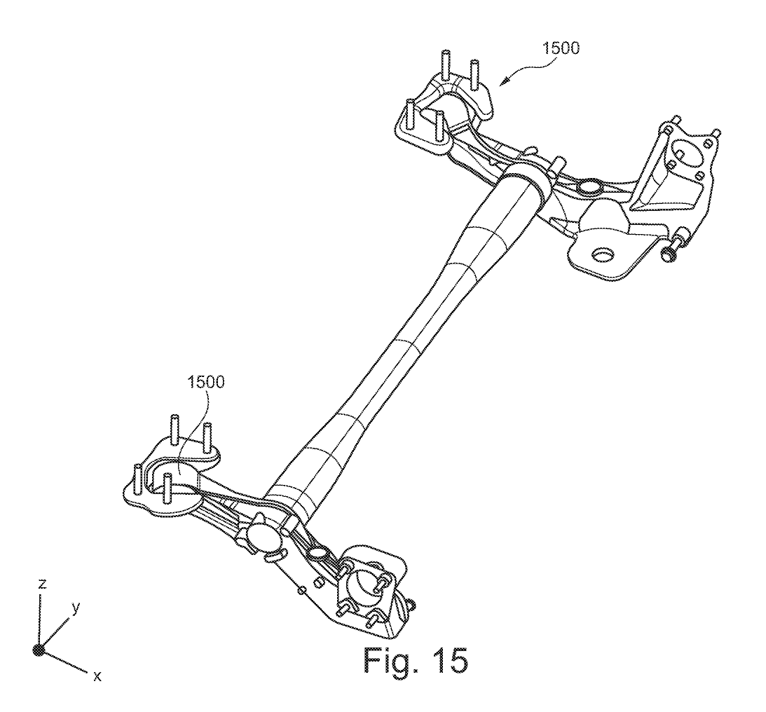

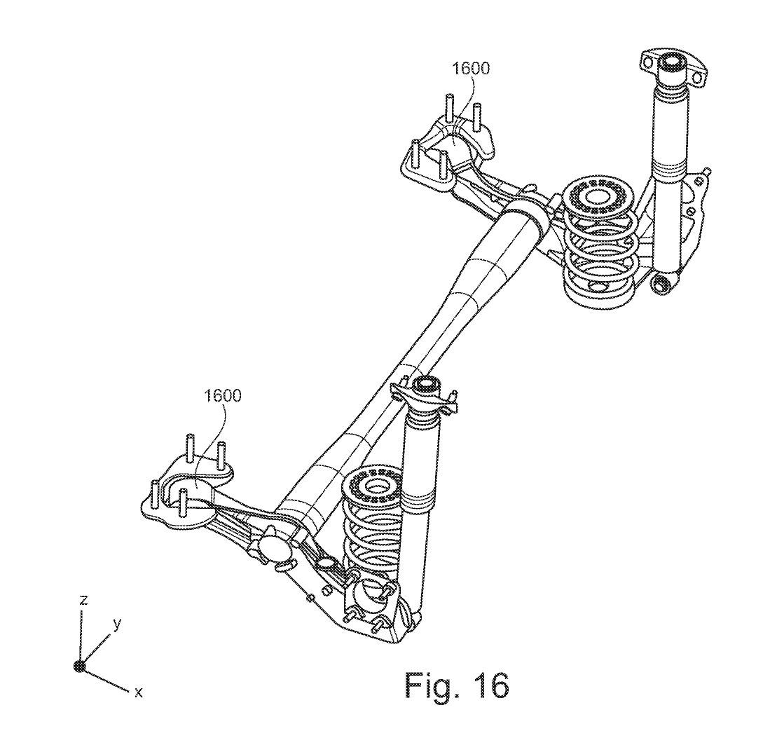

FIG. 15 and FIG. 16 shows embodiments of torsion-beam rear axles 1501, 1601 with a horizontal damping bushing by analogy with FIGS. 13A and 13B but without the Watt linkage. The bushing outer sleeve 1500, 1600 of the damping bushing is here connected to the axle. It is understood that the positions of the bushings shown here can also be selected for torsion-beam rear axles with a Watt linkage, as shown in FIG. 13A and FIG. 13B.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A damping bushing for an axle bearing of a trailing arm of a torsion-beam rear axle, comprising:
a bushing outer sleeve;
a bushing inner sleeve disposed coaxially hereto; and
an interposed damping body,
wherein the bushing inner sleeve is adapted to form a radially outwardly extending and substantially spherical surface and the damping bushing has a further element that abuts extensively against the spherical surface.

2. The damping bushing according to claim 1, wherein the further element is configured as a vulcanization layer of the interposed damping body.

3. The damping bushing according to claim 1, wherein the further element is an additional damping element that is disposed substantially coaxially to the interposed damping body and to the bushing inner sleeve between the interposed damping body and the bushing inner sleeve.

4. The damping bushing according to claim 1, wherein the further element is a ball cup element that is disposed substantially coaxially to the interposed damping body and to the bushing inner sleeve between the interposed damping body and the bushing inner sleeve and forms a ball joint with the bushing inner sleeve.

5. The damping bushing according to claim 3, further comprising an intermediate sleeve that is disposed substantially coaxially to the interposed damping body and to the additional damping element between the interposed damping body and the additional damping element.

6. The damping bushing according to claim 4, further comprising an outer shell for the ball joint that is disposed substantially coaxially to the ball cup element and to the interposed damping body between the ball cup element and the interposed damping body.

7. The damping bushing according to claim 1, further comprising a sealing element that seals toward an outside of at least the spherical surface of the bushing inner sleeve and the further element adapted to adjoin the bushing inner sleeve, wherein the sealing element is configured as sealing bellows.

8. A torsion-beam rear axle for a motor vehicle having a vehicle body, comprising:
a first wheel-carrying trailing arm;
a second wheel-carrying trailing arm; and
a torsionally soft cross-tie connected to the first wheel-carrying trailing arm and the second wheel-carrying trailing arm and disposed ahead of a wheel center in a direction of travel and fastened to the vehicle body with axle bearings,
wherein the axle bearings of the first wheel-carrying trailing arm and the second wheel-carrying trailing arm are each fitted with a damping bushing, the damping bushing comprising:
a bushing outer sleeve;
a bushing inner sleeve disposed coaxially hereto; and
an interposed damping body,
wherein the bushing inner sleeve is adapted to form a radially outwardly extending and substantially spherical surface and the damping bushing has a further element that abuts extensively against the spherical surface.

9. The torsion-beam rear axle according to claim 8, wherein the further element is configured as a vulcanization layer of the interposed damping body.

10. The torsion-beam rear axle according to claim 8, wherein the further element is an additional damping element that is disposed substantially coaxially to the interposed damping body and to the bushing inner sleeve between the interposed damping body and the bushing inner sleeve.

11. The torsion-beam rear axle according to claim 8, wherein the further element is a ball cup element that is disposed substantially coaxially to the interposed damping body and to the bushing inner sleeve between the interposed damping body and the bushing inner sleeve and forms a ball joint with the bushing inner sleeve.

12. The torsion-beam rear axle according to claim 10 further comprising an intermediate sleeve that is disposed substantially coaxially to the interposed damping body and to the additional damping element between the interposed damping body and the additional damping element.

13. The torsion-beam rear axle according to claim 11, further comprising an outer shell for the ball joint that is disposed substantially coaxially to the ball cup element and to the interposed damping body between the ball cup element and the interposed damping body.

14. The torsion-beam rear axle according to claim 8, further comprising a sealing element that seals toward an outside of at least the spherical surface of the bushing inner sleeve and the further element adapted to adjoin the bushing inner sleeve, wherein the sealing element is configured as sealing bellows.

15. The torsion-beam rear axle according to claim 8, wherein in an operatively installed state of the damping bushing, the damping bushing is firmly connected to a cylindrical bushing retaining element.

16. The torsion-beam rear axle according to claim 8, wherein in an operatively installed state of the damping bushing, the bushing outer sleeve is at a substantially the same time configured as a bushing carrier element for connection to the vehicle body and is fastened thereto.

17. The torsion-beam rear axle according to claim 8, wherein front-side ends of the first wheel-carrying trailing arm and the second wheel-carrying trailing arm are each adapted to form a bearing fork in which the damping bushing is inserted, wherein the bearing fork is formed in at least one piece.

18. The torsion-beam rear axle according to claim 8, wherein the bushing outer sleeve is connected to the vehicle body.

19. A motor vehicle, comprising:
a vehicle body;
a torsion-beam rear axle, comprising:
a first wheel-carrying trailing arm;
a second wheel-carrying trailing arm; and
a torsionally soft cross-tie connected to the first wheel-carrying trailing arm and the second wheel-carrying trailing arm and disposed ahead of a wheel center in a direction of travel and fastened to the vehicle body with axle bearings,
wherein the axle bearings of the first wheel-carrying trailing arm and the second wheel-carrying trailing arm are each fitted with a damping bushing, the damping bushing comprising:
a bushing outer sleeve;
a bushing inner sleeve disposed coaxially hereto; and
an interposed damping body,
wherein the bushing inner sleeve is adapted to form a radially outwardly extending and substantially spherical surface and the damping bushing has a further element that abuts extensively against the spherical surface.
